(19) United States
(12) Patent Application Publication
(10) Pub. No.: US 2019/0247756 A1
(43) Pub. Date: Aug. 15, 2019

(54) INTERACTIVE SPORT COACHING SYSTEM

(71) Applicant: Marlan Campbell, Toronto (CA)

(72) Inventor: Marlan Campbell, Toronto (CA)

(21) Appl. No.: 15/893,555

(22) Filed: Feb. 9, 2018

(51) Int. Cl. A63F 13/828; G06F 17/30; A63F 13/332; A63F 13/65; A63F 13/69; H04L 29/08; G07C 13/00

(52) U.S. Cl. CPC A63F 13/828; G06F 17/30864; A63F 13/332; A63F 13/792; A63F 13/69; H04L 67/306; G07C 13/00; A63F 13/65

(57) ABSTRACT

An interactive sport coaching system is disclosed herein. The interactive sport coaching system includes a server, a software-application, and a communication network. The interactive sport coaching system is useful for providing a user with a means to communicate with a coach of a sports team, and have real time input in the coaching of a sports game as a tangible end result.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### 1. Field of the Invention

The present invention relates generally to the field of sports and more specifically relates to a software application for interactive coaching of sports teams.

### 2. Description of Related Art

While traditional applications of technology for user participation in live events exist, they are generally passive forms of user participation. For example, some traditional entertainment shows allow fans to vote for a winner, but results are not shown until the end of a show, or days or weeks later. Fans can help decide which entertainer ‘wins’, but fans do not decide what activity occurs from minute-to-minute.

Fans have minimal real-time impact on the real-time action. Recently, it has also become a popular activity to view video gaming or “e-sports” events as a spectator. While “e-sports” events allow more opportunity for interactivity, spectators still typically act passively without influencing the outcome of the event.

Further e-sport participation allows users to participate in a fantasy game, where they can choose players and teams, and compete based on statistics corresponding to real time events in the sporting events. While real time events can affect a user's score or standing in traditional applications, the user has no ability to participate or influence. Thus, a suitable solution is desired.

U.S. Pub. No. 2017/0209793 to Reggie Johnson relates to a system and method for live interactive coaching game. The described system and method for live interactive coaching game includes a system and method for allowing spectators to instruct sporting event participants on how to act within the sporting event. This is similar to the traditional role of a coach during sporting events, but the coach would be replaced by interactivity from the spectators. Spectators select certain actions they would like the participants to perform by inputting selections into client electronic devices. The client devices transmit information about the selections to an aggregator. The aggregator receives information from various client devices and updates a coaching display to show the most popular selection. The sporting event participants get information on what actions to perform next from the coaching display.

### BRIEF SUMMARY OF THE INVENTION

In view of the foregoing disadvantages inherent in the known sports art, the present disclosure provides a novel interactive sport coaching system. The general purpose of the present disclosure, which will be described subsequently in greater detail, is to provide a system for allowing user interactive coaching whereby the user can directly influence a live sports event.

An interactive sport coaching system is disclosed herein. The interactive sport coaching system includes a server including: a server-processor; a server-memory which may have a server-database including a plurality of real-time sports events information files, a plurality of sports-teams information files, a plurality of sports-players information files, a plurality of user-profiles, and a plurality of coach-profiles; a software-application downloadable to an electronic-device and including a voting-platform operable via a user-interface on the electronic-device; and a communication network communicably coupling the software-application to the server.

A method of using an interactive sport coaching system is also disclosed herein. The method comprising the steps of: providing the interactive sport coaching system as above; downloading the software application to the electronic-device; creating one of the user-profile and the coach-profile; choosing at least one of the plurality of real time sport event information files, the plurality of real time sport event information files being displayed as a list on the electronic device; choosing at least one of the plurality of sports team information files, the plurality of sports team information files being displayed as a list on the electronic device; and voting on at least one of the plurality of sports-player information files via the voting-platform, the plurality of sports-player information files being displayed as a list within the voting-platform on the electronic-device.

A method of providing an interactive sport coaching system is also disclosed herein. The method of providing the interactive sport coaching system may comprise the steps of: providing the interactive sport coaching system as above; receiving user-information at the server; generating a user-profile based on the user-information via the server-processor; storing the user-profile on the server-database; receiving a command at the server-processor to retrieve at least one of the plurality of real time sport event information files, the plurality of sport team information files, and the plurality of sports player information files from the server-database; transmitting the at least one of the plurality of real time sport event information files, the plurality of sport team information files, and the plurality of sports player information files to the software application for display on the electronic device; receiving at least one fan-vote from the voting-platform at the server-processor via the communication network; generating at least one winner information-file based on the at least one fan-vote; and transmitting the at least one winner information-file from the server-processor to the software application via the communication network.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, an interactive sport coaching system, constructed and operative according to the teachings of the present disclosure.

FIG. 1 is a front perspective of the interactive sport coaching system during an ‘in-use’ condition, according to an embodiment of the disclosure.

FIG. 2 is a flow diagram of the interactive sport coaching system of FIG. 1, according to an embodiment of the present disclosure.

FIG. 3 is a front perspective of the interactive sport coaching system of FIG. 1, according to an embodiment of the present disclosure.

FIG. 4 is a flow diagram of the interactive sport coaching system of FIG. 1, according to an embodiment of the present disclosure.

FIG. 5 is a flow diagram of the interactive sport coaching system of FIG. 1, according to an embodiment of the present disclosure.

FIG. 6 is a flow diagram of the interactive sport coaching system of FIG. 1, according to an embodiment of the present disclosure.

FIG. 7 is a flow diagram illustrating a method of use for interactive sport coaching system, according to an embodiment of the present disclosure.

FIG. 8 is a flow diagram illustrating a method of providing the interactive sport coaching system, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to sports and more particularly to an interactive sport coaching system as used to improve interactive coaching of sports teams.

Generally, disclosed is a pay per use sports application which may bring real time game coaching to a sports fan a home. The present disclosure may provide additional cash flow to leagues and sporting events, may allow sport fans worldwide to interact with their favorite players and teams, and may put an interesting spin on the way sports are traditionally played. The sports application may require a user to subscribe and pay a fee, and the sports application may provide subscribers with an ability to interact with a coach of a sports team. A subscriber may choose which player they would like to play or substitute by voting on a player's team and players number. The choices may be sent via WIFI to the coach of the team and the most voted player will enter the court/field/ring. The vote may require a fee per vote from the subscriber. The sports application may give fans firsthand experience and bring fantasy to reality. Further, the sports application may be downloaded and used on any electronic device.

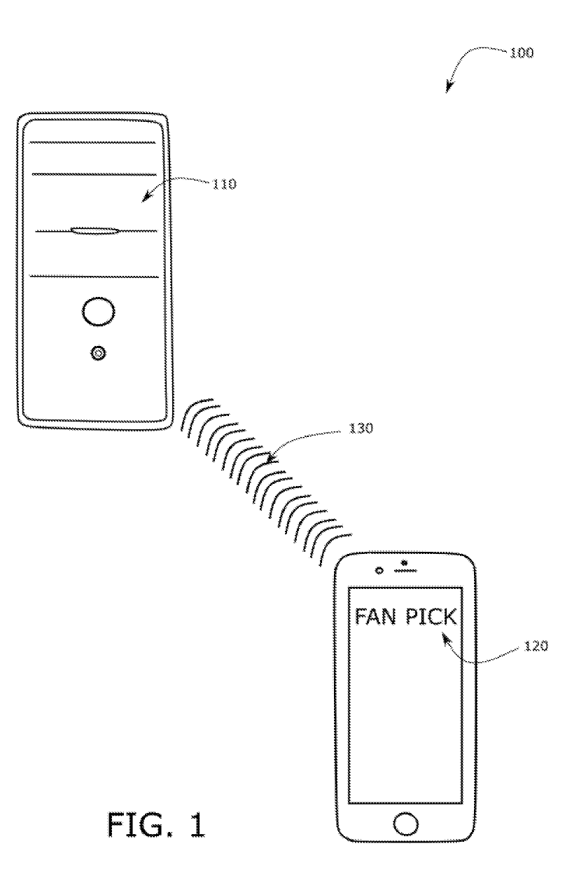

Referring now more specifically to the drawings by numerals of reference, there is shown in FIGS. 1-8, various views and flowcharts of an interactive sport coaching system 100.

FIG. 1 shows an interactive sport coaching system 100 according to an embodiment of the present disclosure. As illustrated, the interactive sport coaching system 100 may include a server 110, a software-application 120 and a communication network 130. As shown, the communication network 130 may be configured for communicably coupling the software-application 120 to the server 110. In one embodiment, the communication network 130 may be a cellular network. In another embodiment, the communication network 130 may be WiFi. Other examples include BLUETOOTH®, peer-to-peer, etc.

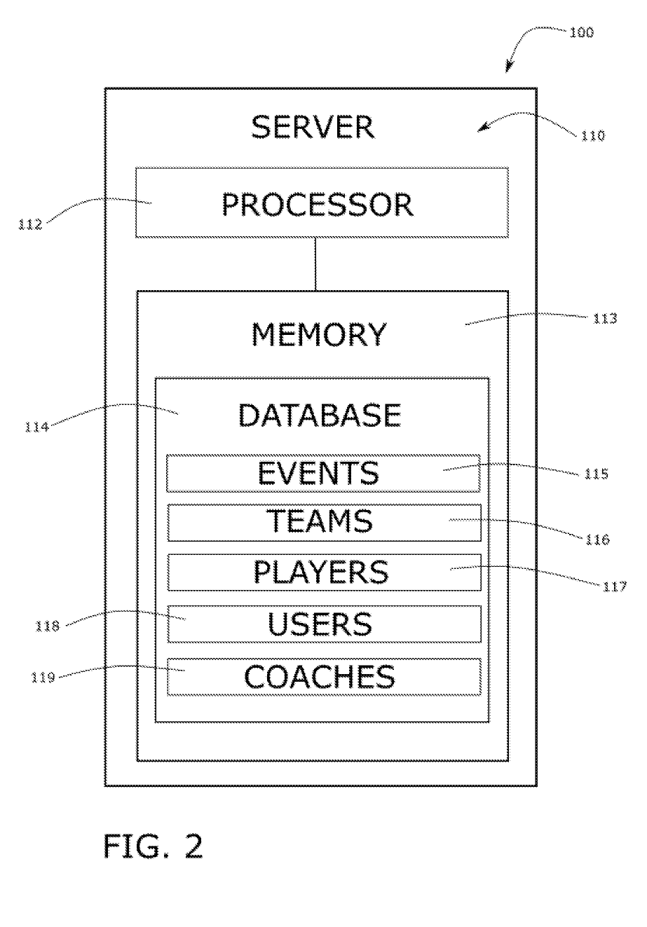

FIG. 2 shows a flow diagram of the interactive sport coaching system 100, according to an embodiment of the present disclosure. As shown, the server 110 may include a server-processor 112 and a server-memory 113. The server-memory 113 may include a server-database 114, the server-database 114 including a plurality of real-time sports events information files 115, a plurality of sports-team information files 116, a plurality of sports-players information files 117, a plurality of user-profiles 118, and a plurality of coach-profiles 119.

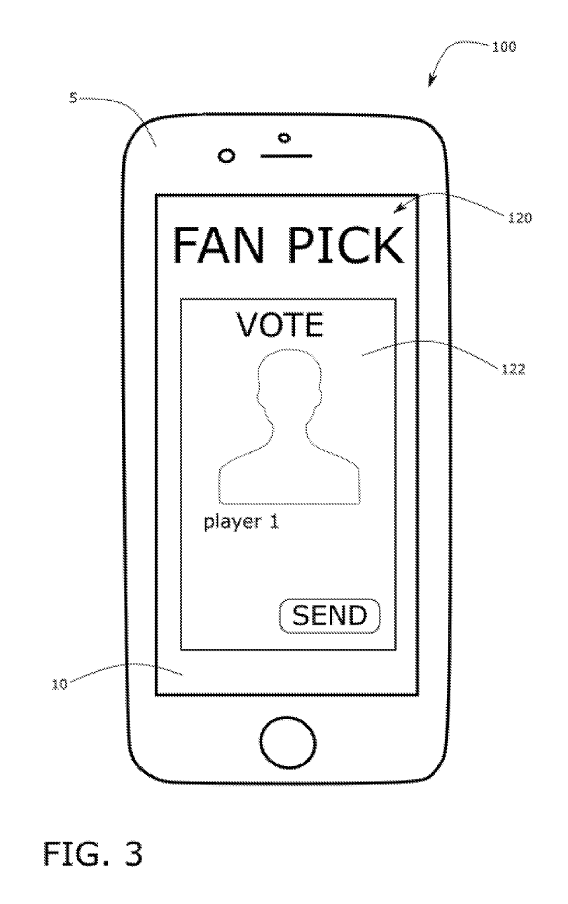

Referring now to FIG. 3 showing a front perspective of the interactive sport coaching system 100, according to an embodiment of the present disclosure. Shown here is the software-application 120. The software-application 120 may be downloadable to an electronic-device 5. The electronic-device 5 shown in this figure is a smartphone, however it should be appreciated that any electronic-device 5 may be used. For examples the electronic-device 5 may be a tablet-computer, a desktop computer, etc. The software-application 120 may include a voting-platform 122 and the voting-platform 122 may be operable via the user-interface 10. The user-interface 10 may be a touchscreen of the electronic-device 5 or a keyboard of the electronic-device 5.

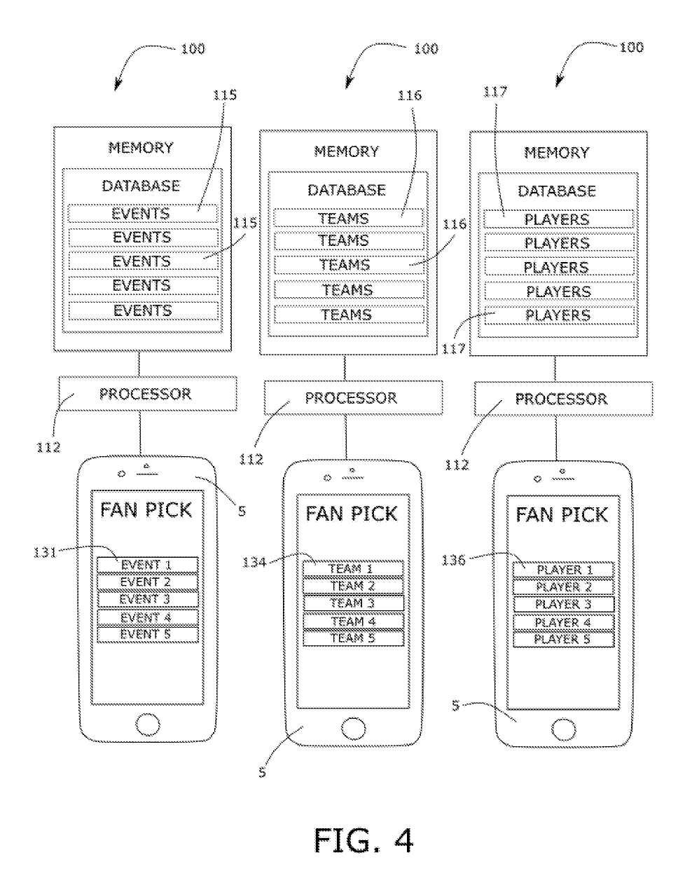

FIG. 4 shows a flow diagram of the interactive sport coaching system 100, according to an embodiment of the present disclosure. As illustrated in this figure, the server-processor 112 may be configured to retrieve the plurality of real-time sports event information files 115 and display them as a first list 131 on the electronic device. In addition, the server-processor 112 may further configured to retrieve the plurality of sports-team information files 116 and display them as a second list 134 on the electronic device, and the server-processor 112 may be configured to retrieve the plurality of sports-player information files 117 and display them as a third list 136 on the electronic device 5. Each of the plurality of sports-player information files 117 may include a player-number, a player-name, and a player-position.

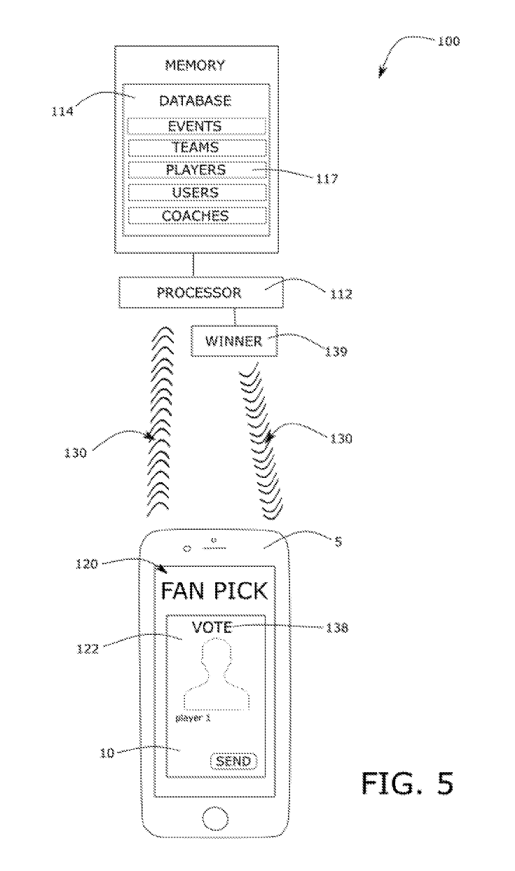

Referring now to FIG. 5 which shows a flow diagram of the interactive sport coaching system 100, according to an embodiment of the present disclosure. As shown, the communication network 130 may be configured to transmit the plurality of sports-players information files 117 to the software-application 120 and the plurality of sports-player information files 117 may be chosen by the user via the voting-platform 122. In this embodiment, the voting-platform 122 provides a means for a user to submit at least one fan-vote 138 via the user-interface 10. Once the user submits their fan-vote 138 via the user-interface 10 on the voting-platform 122, the communication network 130 may then be configured to transmit the at least one fan-vote 138 from the voting-platform 122 to the server-processor 112.

Once received by the server-processor 112, the server-processor 112 may be configured to generate at least one winner information-file 139 based on the at least one fan-vote 138. As shown, after the at least one winner information-file 139 has been generated by the server-processor 112, the communications-network 130 may be configured to transmit the at least one winner information-file 139 from the server-processor 112 to the software application 120. Further, the server-processor 112 may be configured to automatically update the server-database 114 with real-time sports events.

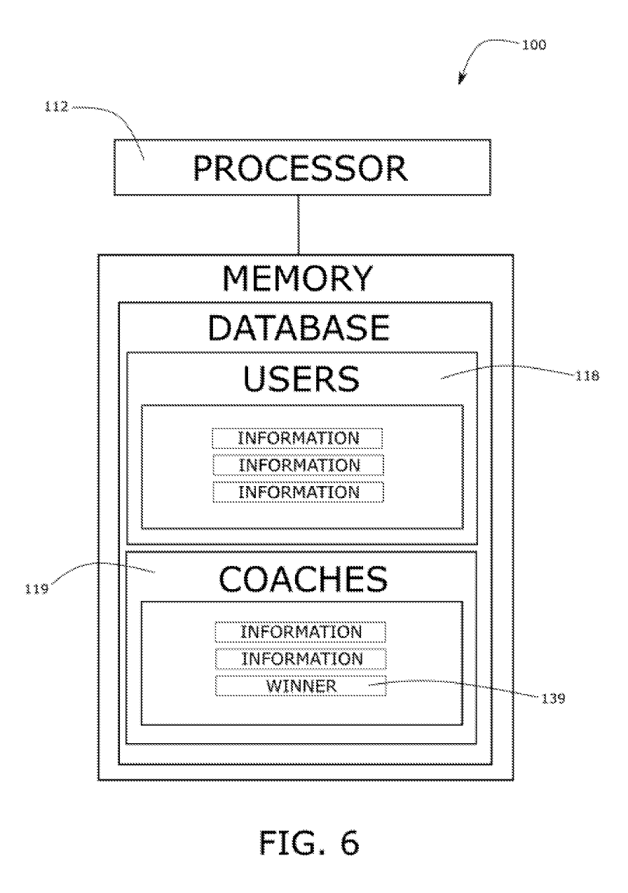

Referring now to FIG. 6 showing a flow diagram of the interactive sport coaching system 100, according to an embodiment of the present disclosure. As shown, the plurality of user-profiles 118 may each include user-specific information. The user-specific information may include information such as user-name, user-age, user-favorites, and the like. The plurality of user-profile 118 may only display user-specific information to the user. Such that the server-processor 112 only retrieves certain information for each user-profile 116. Further, the plurality of coach-profile 119 may each include coach-specific information. The coach-specific information may include team-information only viewable by a specific coach. Further, the coach-specific information may include the at least one winner information file 139. In this embodiment, the at least one winner information may be solely communicated to the coach-profile 119 so that the coach is able to see the winner of the votes, and act accordingly. In some embodiments, the at least one winner information file 139 may then be communicated to the user-profiles 118.

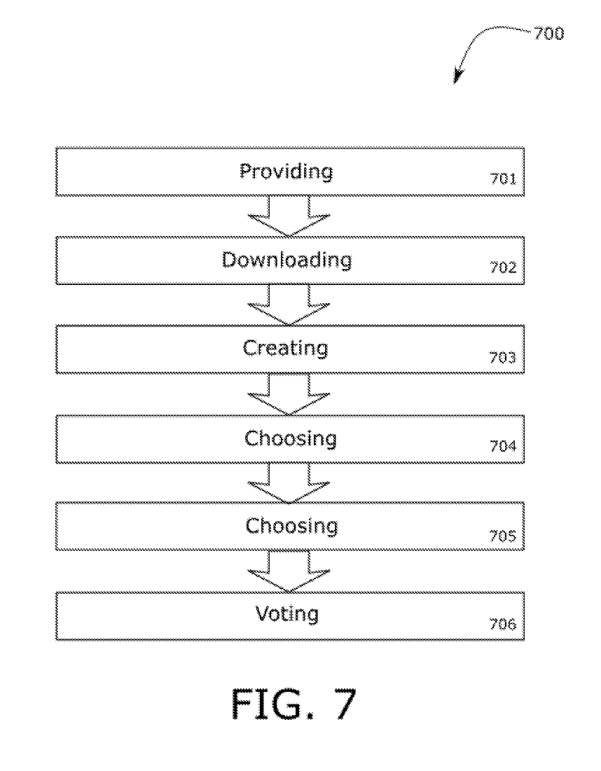

FIG. 7 is a flow diagram illustrating a method of using an interactive sport coaching system for use with an electronic-device 700, according to an embodiment of the present disclosure. As illustrated, the method of providing an interactive sport coaching system for use with an electronic-device 700 may include the steps of: step one 701 a providing the interactive sport coaching system 100 as above; step two 702, downloading the software application 120 to the electronic-device 5; step three 703, creating one of the user-profile 116 and the coach-profile 119; step four 704, choosing at least one of the plurality of real time sport event information files 115, the plurality of real time sport event information files 116 being displayed as a first list 132 on the electronic-device 5; step five 705, choosing at least one of the plurality of sports team information files 116, the plurality of sports team information files 116 being displayed as a second list 134 on the electronic device; and step six 706, voting on at least one of the plurality of sports-player information files 117 via the voting-platform 122, the plurality of sports-player information files 117 being displayed as a third list 136 within the voting-platform 122 on the electronic-device 5.

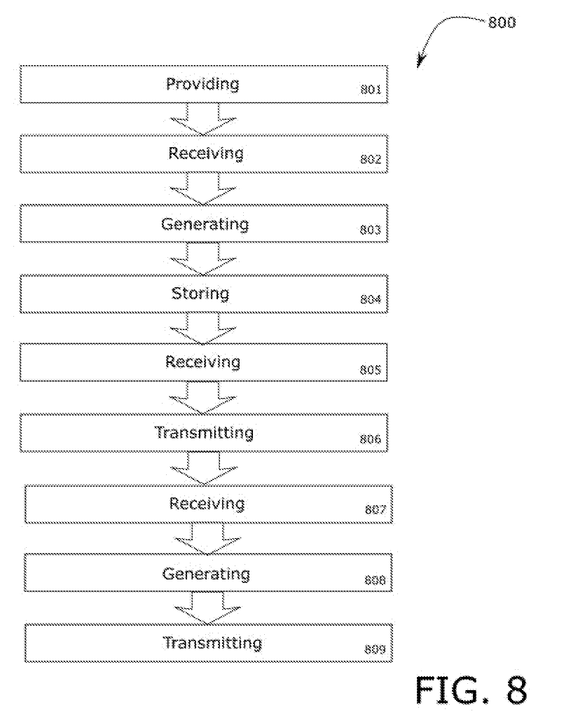

Referring now to FIG. 8, a flow diagram illustrating a method of providing an interactive sport coaching system for use with an electronic-device 800, according to an embodiment of the present disclosure. As illustrated, the method of providing an interactive sport coaching system for use with an electronic-device 800 may include the steps of: step one 801, providing the interactive sport coaching system 100 as above; step two 802, receiving user-information at the server 110; step three 803, generating a user-profile 116 based on the user-information via the server-processor 112; step four 804, storing the user-profile 116 on the server-database 114; step five 805, receiving a command at the server-processor 112 to retrieve at least one of the plurality of real time sport event information files 115, the plurality of sport team information files 116, and the plurality of sports player information files 117 from the server-database 114; step six 806, transmitting the at least one of the plurality of real time sport event information files 115, the plurality of sport team information files 116, and the plurality of sports player information files 117 to the software application 120 for display on the electronic device 5; step seven 807, receiving at least one fan-vote 138 from the voting-platform 122 at the server-processor 112 via the communication network 130; step eight 808, generating at least one winner information-file 139 based on the at least one fan-vote 138; and step nine 809, transmitting the at least one winner information-file 139 from the server-processor 112 to the software application via the communication network 130.

It should be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods for interactive sport coaching system 100 (e.g., different step orders within above-mentioned list, elimination or addition of certain steps, including or excluding certain maintenance steps, etc.), are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. An interactive sport coaching system for use with an electronic-device, the electronic-device including a user-interface, the interactive sport coaching system comprising:
a server including:
a server-processor;
a server-memory having;
a server-database, the server-database including a plurality of real-time sports events information files, a plurality of sports-teams information files, a plurality of sports-players information files, a plurality of user-profiles, and a plurality of coach-profiles;
a software-application downloadable to the electronic-device, the software-application including a voting-platform, and wherein the voting-platform is operable via the user-interface; and
a communication network communicably coupling the software-application to the server.

2. The interactive sport coaching system of claim 1, wherein the server-processor is configured to retrieve the plurality of real-time sports event information files and display them as a first list on the electronic device.

3. The interactive sport coaching system of claim 2, wherein the server-processor is further configured to retrieve the plurality of sports-team information files and display them as a second list on the electronic device.

4. The interactive sport coaching system of claim 3, wherein the server-processor is configured to retrieve the plurality of sports-player information files and display them as a third list on the electronic device.

5. The interactive sport coaching system of claim 4, wherein the communications network is configured to transmit the plurality of sports-players information files to the software application; and
wherein the plurality of sports-player information files are chosen via the voting-platform.

6. The interactive sport coaching system of claim 1, wherein the voting-platform provides a means for a user to submit at least one fan-vote via the user-interface.

7. The interactive sport coaching system of claim 6, wherein the communications network is configured to transmit the at least one fan-vote from the voting-platform to the server-processor.

8. The interactive sport coaching system of claim 7, wherein the server-processor is configured to generate at least one winner information-file based on the at least one fan-vote.

9. The interactive sport coaching system of claim 8, wherein the communications-network is configured to transmit the at least one winner information-file from the server-processor to the software application.

10. The interactive sport coaching system of claim 9, wherein the user-profile includes user-specific information.

11. The interactive sport coaching system of claim 10, wherein the coach-profile includes coach-specific information.

12. The interactive sport coaching system of claim 11, wherein the coach-specific information includes the at least one winner information-file.

13. The interactive sport coaching system of claim 1, wherein each of the plurality of sports-players information files includes a player-number.

14. The interactive sport coaching system of claim 13, wherein each of the plurality of sports-players information files includes a player-name.

15. The interactive sport coaching system of claim 14, wherein each of the plurality of sports-players information files includes a player-position.

16. The interactive sport coaching system of claim 16, wherein the server-processor is configured to automatically update the server-database with real-time sports events.

17. The interactive sport coaching system of claim 1, wherein the communication network is a cellular network.

18. The interactive sport coaching system of claim 17, wherein the communication network is WIFI.

19. A method of using an interactive sport coaching system with an electronic-device, the electronic-device including a user-interface, the method comprising the steps of:
providing an interactive sport coaching system including:
a server including:
a server-processor;
a server-memory having;
a server-database, the server-database including a plurality of real-time sports events information files, a plurality of sports-teams information files, a plurality of sports-players information files, a plurality of user-profiles, and a plurality of coach-profiles;
a software-application downloadable to the electronic-device, the software-application including a voting-platform, and wherein the voting-platform is operable via the user-interface; and
communication network communicably coupling the software-application to the server;
downloading the software application to the electronic-device;
creating one of the user-profile and the coach-profile;
choosing at least one of the plurality of real time sport event information files, the plurality of real time sport event information files being displayed as a first list on the electronic device;
choosing at least one of the plurality of sports team information files, the plurality of sports team information files being displayed as a second list on the electronic device; and
voting on at least one of the plurality of sports-player information files via the voting-platform, the plurality of sports-player information files being displayed as a third list within the voting-platform on the electronic-device.

20. A method of providing an interactive sport coaching system for use with an electronic-device, the electronic-device including a user-interface, the method comprising the steps of:
providing an interactive sport coaching system including:
a server including:
a server-processor;
a server-memory having;
a server-database, the server-database including a plurality of real-time sports events information files, a plurality of sports-team information files, a plurality of sports-players information files, a plurality of user-profiles, and a plurality of coach-profiles;
a software-application downloadable to the electronic-device, the software-application including a voting-platform, and wherein the voting-platform is operable via the user-interface; and
a communication network communicably coupling the software-application to the server;
receiving user-information at the server;
generating a user-profile based on the user-information via the server-processor;
storing the user-profile on the server-database;
receiving a command at the server-processor to retrieve at least one of the plurality of real time sport event information files, the plurality of sport team information files, and the plurality of sports player information files from the server-database;
transmitting the at least one of the plurality of real time sport event information files, the plurality of sport team information files, and the plurality of sports player information files to the software application for display on the electronic device;
receiving at least one fan-vote from the voting-platform at the server-processor via the communication network;
generating at least one winner information-file based on the at least one fan-vote; and
transmitting the at least one winner information-file from the server-processor to the software application via the communication network.
